(19) United States
(12) Patent Application Publication
(10) Pub. No.: US 2023/0092861 A1
(43) Pub. Date: Mar. 23, 2023

(54) COMMUNICATION-BASED VEHICLE SAFETY MESSAGE GENERATION AND PROCESSING

(71) Applicant: GM Global Technology Operations LLC, Detroit, MI (US)

(72) Inventor: Jimmy Qi, Shanghai (CN)

(21) Appl. No.: 17/479,044

(22) Filed: Sep. 20, 2021

(51) Int. Cl. B60W 30/095; G06K 9/62

(52) U.S. Cl. CPC B60W 30/095; G06K 9/6288; B60W 2420/42; B60W 2554/4049; B60W 2554/4041; B60W 2555/20

(57) ABSTRACT

A system in a vehicle includes one or more sensors to provide data, the one or more sensors including one or more cameras. The system also includes processing circuitry to obtain sensor information based on the data. The sensor information includes a position of one or more features around the vehicle, the one or more features being stationary objects. The processing circuitry additionally obtains information from messages, fuses the sensor information and the information from the messages, and generates and broadcasts an adaptive safety message based on fusion that does not include a satellite-based position of the vehicle.

### INTRODUCTION

The subject disclosure relates to communication-based vehicle safety message generation and processing.

Vehicles (e.g., automobiles, motorcycles, trucks, construction equipment) increasingly use sensors and communication systems to enhance operation. For example, some sensors (e.g., inertial measurement unit (IMU), wheel angle sensor) may provide information about the vehicle, while other sensors (e.g., cameras, lidar systems, radar systems) provide information about the environment around the vehicle. The information may facilitate semi-autonomous actions (e.g., adaptive cruise control, automatic braking) or autonomous operation of the vehicle or may facilitate providing alerts to the driver.

Vehicle-to-vehicle (V2V) communication, vehicle-to-infrastructure (V2I) communication, and, generally, vehicle-to-everything (V2X) communication may also enhance vehicle operation. Generally, a global navigation satellite system (GNSS), such as the global positioning system (GPS), may provide the position of the vehicle such that information and messages in its vicinity and, thus, relevant to the vehicle, may be readily discernable. However, GNSS positioning is not always available (e.g., in a tunnel or underground garage). Accordingly, it is desirable to provide communication-based vehicle safety message generation and processing.

### SUMMARY

In one exemplary embodiment, a system in a vehicle includes one or more sensors to provide data, the one or more sensors including one or more cameras. The system also includes processing circuitry to obtain sensor information based on the data, the sensor information including a position of one or more features around the vehicle, the one or more features being stationary objects. The processing circuitry obtains information from messages, fuses the sensor information and the information from the messages, and generates and broadcasts an adaptive safety message based on fusion that does not include a satellite-based position of the vehicle.

In addition to one or more of the features described herein, the processing circuitry checks whether a satellite-based position of the vehicle is available.

In addition to one or more of the features described herein, the processing circuitry determines whether the satellite-based position is available with a required level of confidence according to signal strength or stability.

In addition to one or more of the features described herein, the processing circuitry generates the adaptive safety message based on the satellite-based position not being available.

In addition to one or more of the features described herein, the processing circuitry obtains the information from one or more vehicle-to-vehicle messages from one or more other vehicles.

In addition to one or more of the features described herein, the processing circuitry obtains the information from a stationary communication unit.

In addition to one or more of the features described herein, the information indicates a position of at least one of the one or more features.

In addition to one or more of the features described herein, the processing circuitry fuses the sensor information and the information based on the position of the at least one of the one or more features indicated by the sensor information and by the information.

In addition to one or more of the features described herein, the adaptive safety message includes the one or more features.

In addition to one or more of the features described herein, the adaptive safety message includes weather information.

In another exemplary embodiment, a method in a vehicle includes obtaining data from one or more sensors, the one or more sensors including one or more cameras. The method also includes obtaining sensor information based on the data, the sensor information including a position of one or more features around the vehicle, the one or more features being stationary objects. Additionally, the method includes obtaining information from messages, fusing the sensor information and the information from the messages, and generating and broadcasting an adaptive safety message based on the fusing, the adaptive safety message not including a satellite-based position of the vehicle.

In addition to one or more of the features described herein, the method also includes checking whether a satellite-based position of the vehicle is available.

In addition to one or more of the features described herein, the checking includes determining whether the satellite-based position is available with a required level of confidence according to signal strength or stability.

In addition to one or more of the features described herein, the generating the adaptive safety message is based on the satellite-based position not being available.

In addition to one or more of the features described herein, the obtaining the information is from one or more vehicle-to-vehicle messages from one or more other vehicles.

In addition to one or more of the features described herein, the obtaining the information is from a stationary communication unit.

In addition to one or more of the features described herein, the obtaining the information includes the information indicating a position of at least one of the one or more features.

In addition to one or more of the features described herein, the fusing the sensor information and the information is based on the position of the at least one of the one or more features indicated by the sensor information and by the information.

In addition to one or more of the features described herein, the generating the adaptive safety message includes indicating the one or more features.

In addition to one or more of the features described herein, the generating the adaptive safety message includes indicating weather information.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that implements communication-based vehicle safety message generation and processing according to one or more embodiments;

FIG. 2 shows a scenario in which a vehicle implements communication-based vehicle safety message generation and processing according to one or more embodiments;

FIG. 3 is a process flow of a method of generating a communication-based vehicle safety message (i.e., an adaptive safety message) according to one or more embodiments; and

FIG. 4 is a process flow of a method of processing a received adaptive safety message according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, a vehicle may use information from sensors, as well as information received via messages, to make decisions regarding the semi-autonomous or autonomous operation of the vehicle or to present alerts to the driver. For example, a subject vehicle (referred to as an ego vehicle) may receive a basic safety message (BSM) that includes information about the position, heading, and speed of other vehicles in the vicinity, as well as their state and predicted path. Typically, a BSM includes the GNSS-based position of the other vehicles. Similarly, when the ego vehicle generates a BSM, it includes its own GNSS-based position along with other information. However, when the ego vehicle or one or more of the other vehicles does not have access to a GNSS-based position (e.g., in a tunnel, in an underground garage, in an area with tall buildings or trees), the typical BSM cannot be generated.

Embodiments of the systems and methods detailed herein relate to communication-based vehicle safety message generation and processing. As detailed, when a GNSS-based position is not available, an ego vehicle may fuse road features and other information obtained with its sensors with information obtained via communication. The communication may be with other vehicles and other sources (e.g., roadside units (RSUs)). The ego vehicle may generate a communication-based vehicle safety message, which differs from the standard BSM and may be referred to as an adaptive safety message for explanatory purposes, based on the fusion of information obtained via its sensors and communication. As also detailed, when an ego vehicle receives an adaptive safety message rather than the standard BSM, the ego vehicle may process the information in the adaptive safety message along with information obtained via its own sensors and other BSMs to make determinations and decisions.

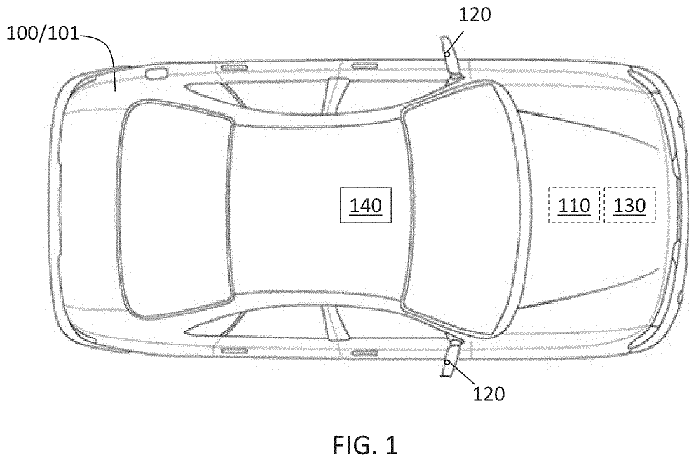

In accordance with an exemplary embodiment, FIG. 1 is a block diagram of a vehicle 100 that implements communication-based vehicle safety message generation and processing. The exemplary vehicle 100 shown in FIG. 1 is an automobile 101. The vehicle 100 includes a controller 110 and may include a number of sensors such as cameras 120, a radar system 130, and a lidar system 140. The numbers and positions of the exemplary sensors shown in FIG. 1 are not intended to be limiting. The controller 110 may obtain information from the sensors and control one or more operations of the vehicle 100.

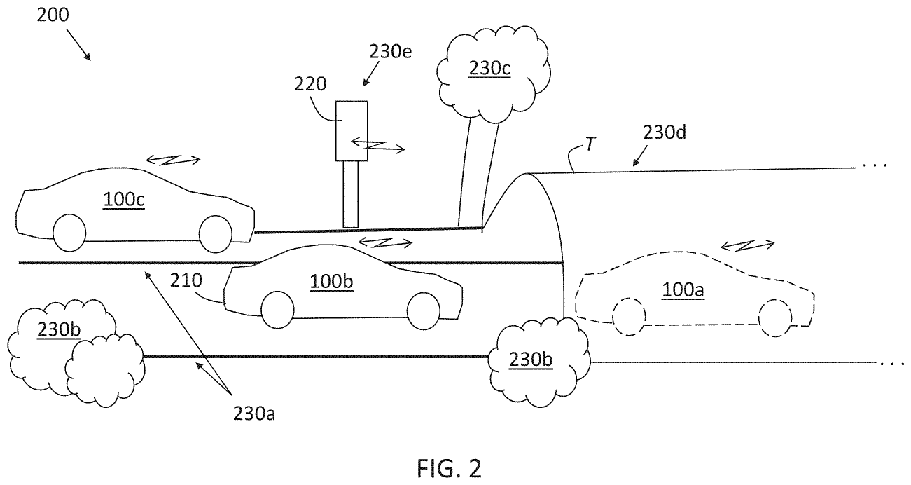

According to one or more embodiments, the controller 110 may generate communication-based vehicle safety messages (i.e., adaptive safety messages) and process received adaptive safety messages. Features 230 (FIG. 2) may be identified by the controller 110, by a controller within a given sensor, or by a combination of the two. The controller 110 and any controller within any of the sensors may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

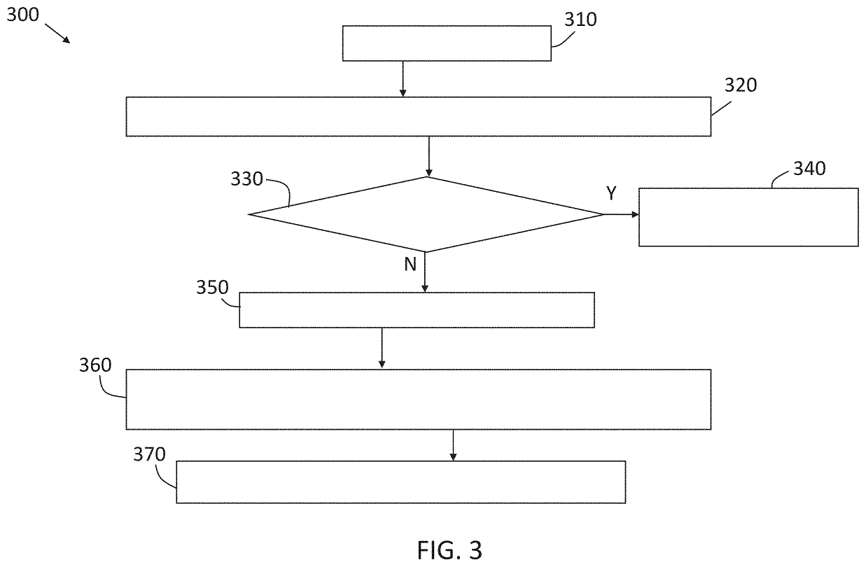

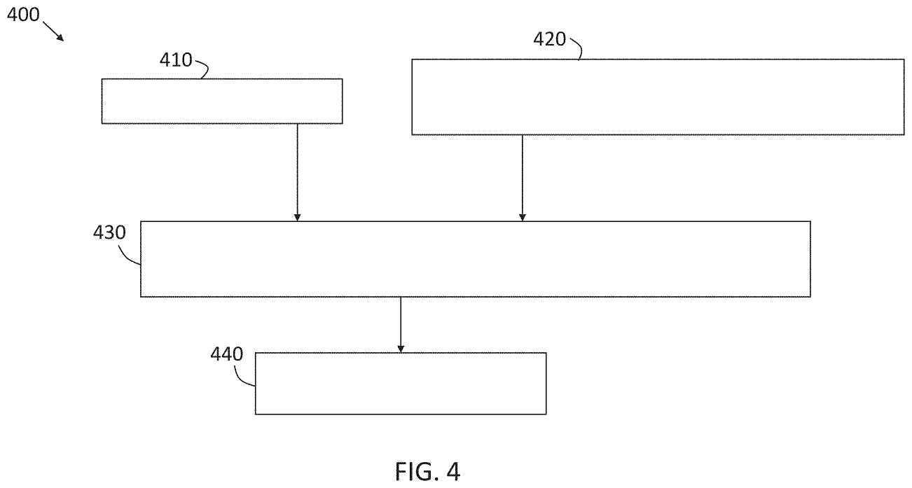

FIG. 2 shows a scene 200 in which a vehicle 100b implements communication-based vehicle safety message generation and processing according to one or more embodiments. In the exemplary scene 200, vehicle 100b is considered as the ego vehicle 210 for explanatory purposes. The vehicle 100a is in a tunnel T ahead of the ego vehicle 210, and the vehicle 100c is in a blind spot of the ego vehicle 210. Generation of an adaptive safety message by the ego vehicle 210, according to one or more embodiments, is detailed with reference to FIG. 3. Processing of a received adaptive safety message by the ego vehicle 210, according to one or more embodiments, is detailed with reference to FIG. 4.

A roadside unit 220 is also shown in FIG. 2. This roadside unit 220 is stationary and may be an edge computing device that provides cloud computing capabilities and communicates within the radio access network (RAN) in a limited area around the roadside unit 220. The RAN facilitates communication even in areas (e.g., tunnels, underground garages, places with buildings or trees) where satellite or cellular signals cannot be used. The exemplary scene 200 includes several features 230 that may be detected and identified. Features 230 refer to the stationary objects in the scene 200. Exemplary features 230 include lane markings 230a, bushes 230b, a tree 230c, the tunnel T 230d, and the roadside unit 220 230e. These are discussed with reference to FIGS. 3 and 4.

FIG. 3 is a process flow of a method 300 of generating a communication-based vehicle safety message (i.e., an adaptive safety message) according to one or more embodiments. The processes may be performed by the controller 110 of the ego vehicle 210. At block 310, obtaining sensor data refers to obtaining information from the cameras 120 of the ego vehicle 210, for example. The cameras 120 may be the same ones used for lane keeping and other advanced driver assist system (ADAS) tasks, for example. Sensor data may also be fused data from cameras 120 and other sensors (e.g., radar system 130, lidar system 140). At block 320, identifying features 230 refers to identifying features 230 associated with the road (e.g., road markings 230a), features 230 associated with infrastructure (e.g., roadside unit 220 230e, tunnel T 230d), and other stationary objects (e.g., bushes 230b, tree 230c) in the scene 200 that are in the field of view of one or more of the sensors from which data is obtained (at block 310). A relative position of each feature 230, relative to the ego vehicle 210, is determined.

At block 330, a check is done of whether GNSS-based positioning is available. This check may entail determining a level of confidence in the GNSS information if a weak satellite signal is received. The confidence level may be sufficient based on required metrics for stability (i.e., signal received for some percentage of a duration) and/or strength of the signal, for example. If GNSS-based positioning is available with a requisite confidence level, then generating a standard BSM message, at block 340, is according to prior approaches. If the check at block 330 indicates that GNSS-based positioning is not available or does not meet a requirement for a confidence level, then the processes at blocks 350, 360, and 370 are performed.

At block 350, obtaining information from messages includes V2V messages from other vehicles 100 (e.g., vehicles 100a, 100c) and V2X messages from the roadside unit 220. The messages provide information about features 230 identified by the other vehicles 100 and the roadside unit 220. At block 360, the processes include fusing sensor information and communication-based information. That is, the features 230 identified at block 320 based on sensor data obtained at block 310 within the ego vehicle 210 are fused with information from one or more messages obtained at block 350. Specifically, at block 360, the features 230 identified by the ego vehicle 210 and the features 230 indicated in V2V messages (e.g., either standard BSMs or adaptive safety messages) and V2X messages (e.g., from the roadside unit 220) are fused to predict the relative positions of the vehicles 100 (e.g., vehicles 100a, 100c) around the ego vehicle 210 (e.g., vehicle 100b). By comparing the position of features 230 identified by the ego vehicle 210 with the position of the same features 230 in the messages (at block 350), relative positions between the ego vehicle 210, other vehicles 100, and the roadside unit 220 may be determined. The fusion may use an extended Kalman filter or other known technique.

At block 370, generating and sending an adaptive safety message refers to the ego vehicle 210 providing the fused information as a broadcast. Specifically, the type of information that may be indicated in the adaptive safety message includes features 230—the position of lane markings 230a, buildings, vegetation (e.g., bushes 230b, trees 230c), infrastructure (e.g., traffic light), obstacles—relative to the ego vehicle 210, weather information, events (e.g., work zone), traffic light state, and sign information. Additionally, the path history of the ego vehicle 210 is broadcast as part of the adaptive safety message. As further discussed with reference to FIG. 4, a vehicle 100 that receives the adaptive safety message from the ego vehicle 210 may use this path history to estimate whether the trajectory of the ego vehicle 210 intersects with its own trajectory and, thus, presents a potential collision hazard. What the adaptive safety message will not include, unlike a standard BSM, is GNSS-based position information for the ego vehicle 210.

The broadcast of the adaptive safety message may be received by the roadside unit 220, as well as by other vehicles 100 in the vicinity. The roadside unit 220 may receive an adaptive safety message from the ego vehicle 210, as well as from one or more other vehicles 100. The roadside unit 220 may gather the features 230 identified in all received adaptive safety messages and fuse them to generate a broader feature map. The roadside unit 220 may then broadcast this enhanced feature map. Subsequent localization performed by the ego vehicle 210 or other vehicles 100 based on the enhanced feature map from the roadside unit 220 may increase efficiency and confidence.

FIG. 4 is a process flow of a method 400 of processing a received vehicle safety message (i.e., an adaptive safety message) according to one or more embodiments. The processes may be performed by the controller 110 of the ego vehicle 210. At block 410, obtaining sensor information refers to obtaining data from the cameras 120, for example, and identifying features 230 similarly to the processes at blocks 310 and 320 in FIG. 3. At block 420, the processes include obtaining one or more standard BSMs from one or more other vehicles 100, a message from a roadside unit 220, and one or more communication-based vehicle safety messages (i.e., adaptive safety messages) from one or more other vehicles 100. For example, the ego vehicle 210 shown in FIG. 2 may obtain a BSM from the vehicle 100c and an adaptive safety message from the vehicle 100a, which is in the tunnel T and cannot obtain a GNSS-based position. The message from the roadside unit 220 may include an enhanced feature map that is based on the roadside unit 220 fusing features 230 from adaptive safety messages from two or more vehicles 100, as previously noted.

At block 430, fusing the information facilitates determining the relative positions of vehicles 100 and other objects (e.g., features 230). When the ego vehicle 210 knowns its own GNSS-based position and obtains a BSM (e.g., from the vehicle 100c), then determining the position of the vehicle 100c relative to the ego vehicle 210 is straight-forward. When the ego vehicle 210 obtains an adaptive safety message (e.g., from the vehicle 100a), then the controller 110 of the ego vehicle 210 determines the relative position of the vehicle 100a based on the features 230 identified in the adaptive safety message and features 230 identified based on its own sensors (at block 410). At block 440, the processes include assessing risks and taking action. For example, the vehicle 100a, which sends an adaptive safety message rather than a BSM due to a lack of a satellite signal in the tunnel T, may brake in the tunnel T ahead of the ego vehicle 210. Based on the processes at block 430, the ego vehicle 210 may slow or issue a warning to the driver of the ego vehicle 210.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A system in a vehicle comprising:
one or more sensors configured to provide data, the one or more sensors including one or more cameras; and
processing circuitry configured to obtain sensor information based on the data, the sensor information including a position of one or more features around the vehicle, the one or more features being stationary objects, to obtain information from messages, to fuse the sensor information and the information from the messages, and to generate and broadcast an adaptive safety message based on fusion that does not include a satellite-based position of the vehicle.

2. The system according to claim 1, wherein the processing circuitry is configured to check whether a satellite-based position of the vehicle is available.

3. The system according to claim 2, wherein the processing circuitry determines whether the satellite-based position is available with a required level of confidence according to signal strength or stability.

4. The system according to claim 2, wherein the processing circuitry generates the adaptive safety message based on the satellite-based position not being available.

5. The system according to claim 1, wherein the processing circuitry is configured to obtain the information from one or more vehicle-to-vehicle messages from one or more other vehicles.

6. The system according to claim 1, wherein the processing circuitry is configured to obtain the information from a stationary communication unit.

7. The system according to claim 1, wherein the information indicates a position of at least one of the one or more features.

8. The system according to claim 1, wherein the processing circuitry is configured to fuse the sensor information and the information based on the position of the at least one of the one or more features indicated by the sensor information and by the information.

9. The system according to claim 1, wherein the adaptive safety message includes the one or more features.

10. The system according to claim 1, wherein the adaptive safety message includes weather information.

11. A method in a vehicle comprising:
obtaining data from one or more sensors, the one or more sensors including one or more cameras;
obtaining sensor information based on the data, the sensor information including a position of one or more features around the vehicle, the one or more features being stationary objects;
obtaining information from messages;
fusing the sensor information and the information from the messages; and
generating and broadcasting an adaptive safety message based on the fusing, the adaptive safety message not including a satellite-based position of the vehicle.

12. The method according to claim 11, further comprising checking whether a satellite-based position of the vehicle is available.

13. The method according to claim 12, wherein the checking includes determining whether the satellite-based position is available with a required level of confidence according to signal strength or stability.

14. The method according to claim 12, wherein the generating the adaptive safety message is based on the satellite-based position not being available.

15. The method according to claim 11, wherein the obtaining the information is from one or more vehicle-to-vehicle messages from one or more other vehicles.

16. The method according to claim 11, wherein the obtaining the information is from a stationary communication unit.

17. The method according to claim 11, wherein the obtaining the information includes the information indicating a position of at least one of the one or more features.

18. The method according to claim 11, wherein the fusing the sensor information and the information is based on the position of the at least one of the one or more features indicated by the sensor information and by the information.

19. The method according to claim 11, wherein the generating the adaptive safety message includes indicating the one or more features.

20. The method according to claim 11, wherein the generating the adaptive safety message includes indicating weather information.
